(19) United States
(12) Patent Application Publication
(10) Pub. No.: US 2010/0066699 A1
(43) Pub. Date: Mar. 18, 2010

(54) Image Displaying Device

(75) Inventor: Yusaku Takahashi, Aichi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/561,359

(22) Filed: Sep. 17, 2009

(30) Foreign Application Priority Data
Sep. 18, 2008 (JP) 2008239393

(51) Int. Cl. G06F 3/041

(52) U.S. Cl. 345/173

(57) ABSTRACT

An image displaying device has an image acquiring unit, an image data storage, a display unit, an input unit, a display position setting unit and an index image displaying unit. The image acquiring unit acquires image data. The image data storage stores the image data. The display unit displays index images corresponding to the image data. The input unit allows a user to designate a position on the display unit and generate input position information representing the designated position. The display position setting unit sets a display position of each of the index images in accordance with the position information generated by the input unit, when the image data is acquired by the image acquiring unit. The index image displaying unit displays the index images at the respective display positions set by the display position setting unit.

### CROSS-REFERENCE TO RELATED APPLICATION

This application claims priority under 35 U.S.C. §119 from Japanese Patent Application No. 2008-239393 filed on Sep. 18, 2008. The entire subject matter of the application is incorporated herein by reference.

### BACKGROUND

1. Technical Field

Aspects of the invention relate to an image displaying device.

2. Related Art

There is known a displaying device configured such that when a user designates image data displayed on a displaying device and the user slides a finger on a touch panel in a certain direction, a predetermined process (e.g., printing, circulating, storing, etc.) corresponding to the direction where the user slid the finger is applied to the image data.

### SUMMARY

In such a displaying device, when a plurality of pieces of image data are stored in a memory, a plurality of index images are displayed on the displaying device.

Aspects of the invention provide an improved displaying device which allows a user to find a desired index image easily from among a plurality of index images displayed on the displaying device corresponding to a plurality of pieces of image data, and also decreases burden of a user operation for managing the image data.

According to aspects of the invention, there is provided an image displaying device including an image acquiring unit, an image data storage, a display unit, an input unit, a display position setting unit and an index image displaying unit. The image acquiring unit acquires image data. The image data storage stores the image data. The display unit displays index images corresponding to the image data stored in the image data storage. The input unit allows a user to designate a position on the display unit and generate input position information representing the designated position. The display position setting unit sets a display position of each of the index images corresponding to the image data in accordance with the position information generated by the input unit, when the image data is acquired by the image acquiring unit. The index image displaying unit displays the index images corresponding to the image data stored in the image data storage at the respective display positions set by the display position setting unit.

### BRIEF DESCRIPTION OF THE ACCOMPANYING DRAWINGS

FIG. 1 is a block diagram schematically showing an electrical configuration of an MFP (Multi-Function Peripheral) according to aspects of the invention.

FIG. 2A shows an example of images displayed on an image display area of an LCD (Liquid Crystal Display) when a scan mode is selected.

FIG. 2B an example of images displayed on the image display area of the LCD when new image data is generated by a scanner.

FIG. 3 schematically shows a configuration of a virtual area management memory.

FIG. 4 shows a flowchart illustrating a scanning process executed by a CPU of an MFP.

FIG. 5 shows a flowchart illustrating a file image movement process executed by the CPU of the MFP.

FIG. 6 shows a flowchart illustrating a file referring process executed by the CPU of the MFP.

### DETAILED DESCRIPTION OF THE EMBODIMENT

Referring to the accompanying drawings, an exemplary embodiment according to aspects of the invention will be described.

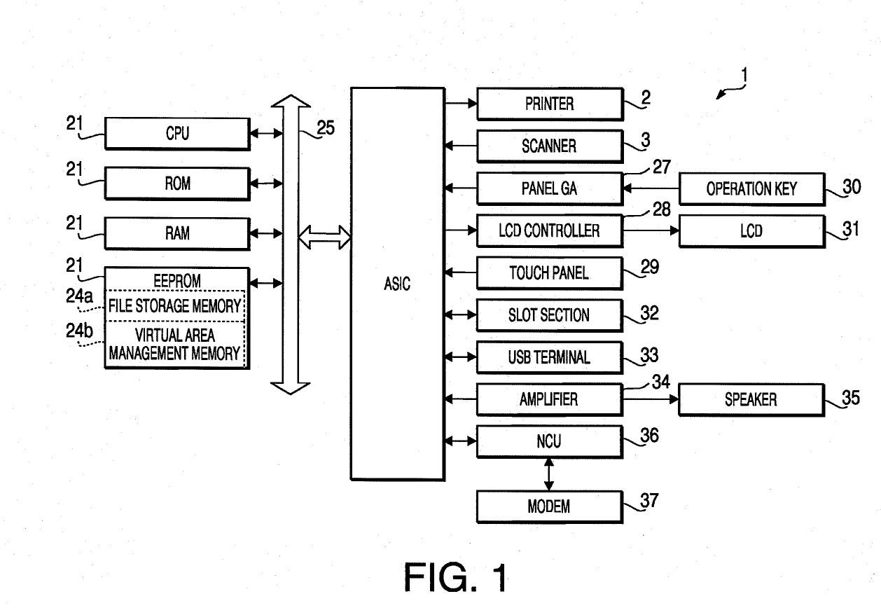

As shown in FIG. 1, an MFP 1 includes a microcomputer provided with a CPU (Central Processing Unit) 21, a ROM (Read Only Memory) 22, a RAM (Random Access Memory) 23 and an EEPROM (Electrically Erasable and Programmable ROM) 24, a bus 25, an ASIC (Application Specific Integrated Circuit) 26, a printer 2, a scanner 3, a panel gate array (panel GA) 27, an LCD controller 28, a touch panel 29, an operation key 30, an LCD 31, a slot section 32, a USB terminal 33, an amplifier 34, a speaker 35, an NCU (Network Control Unit) 36 and a modem 37.

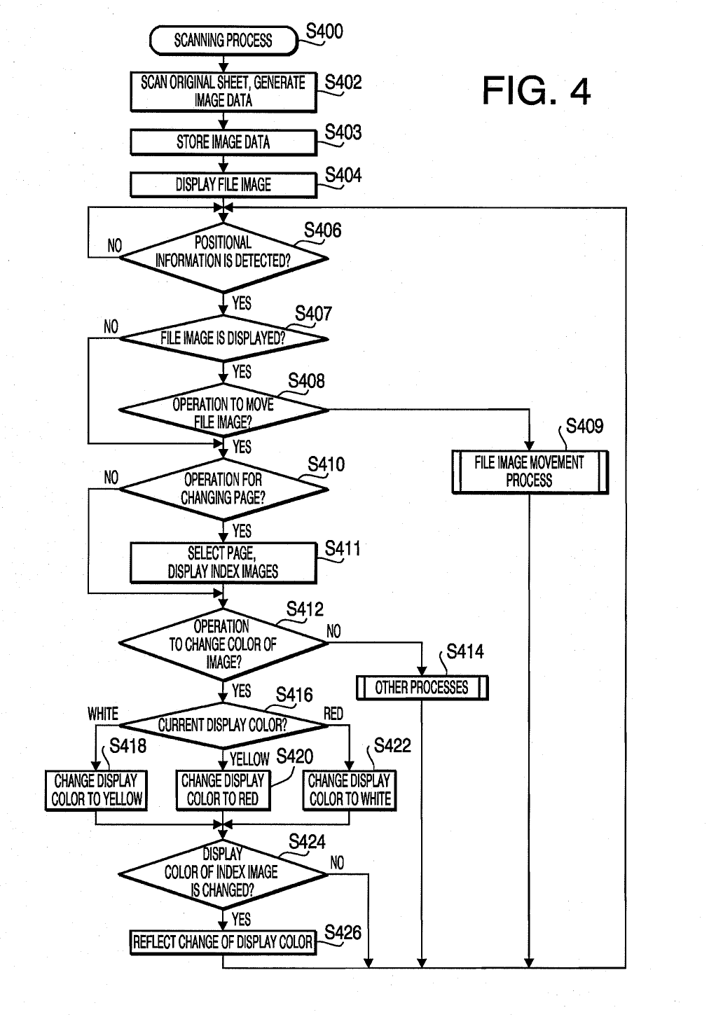

The CPU 21 controls an entire operation of the MFP 1 by executing programs corresponding to processes including ones shown in FIGS. 4-6. The ROM 22 stores such programs for controlling the operations of the MFP 1. The RAM 23 serves as a storage and/or a work area for temporarily storing various pieces of data which are used when the CPU 21 executes the programs.

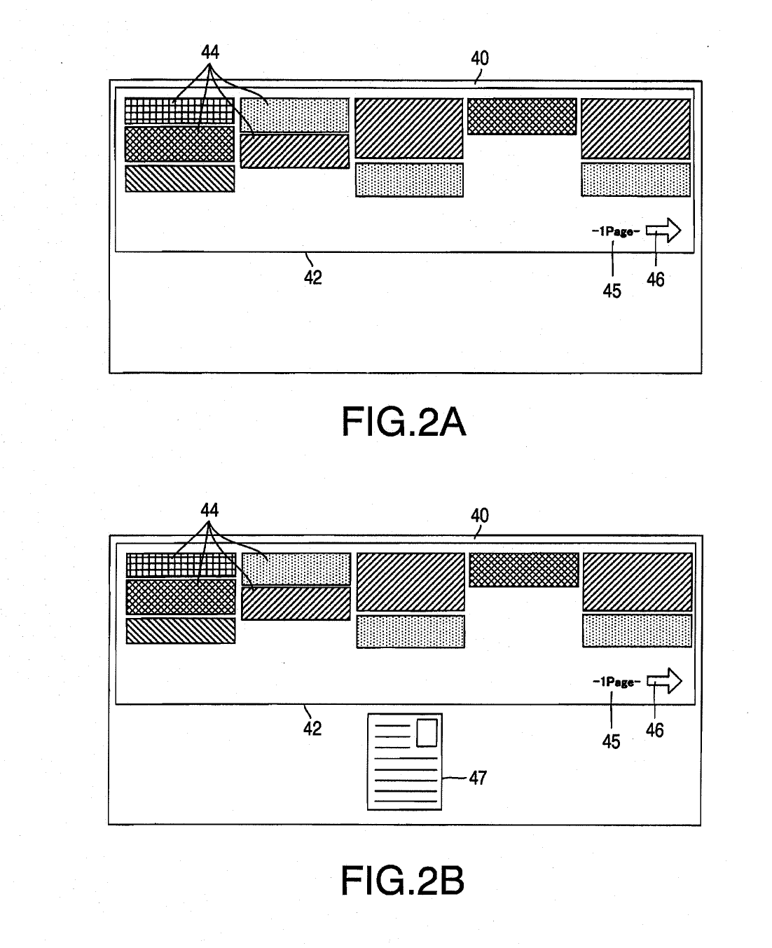

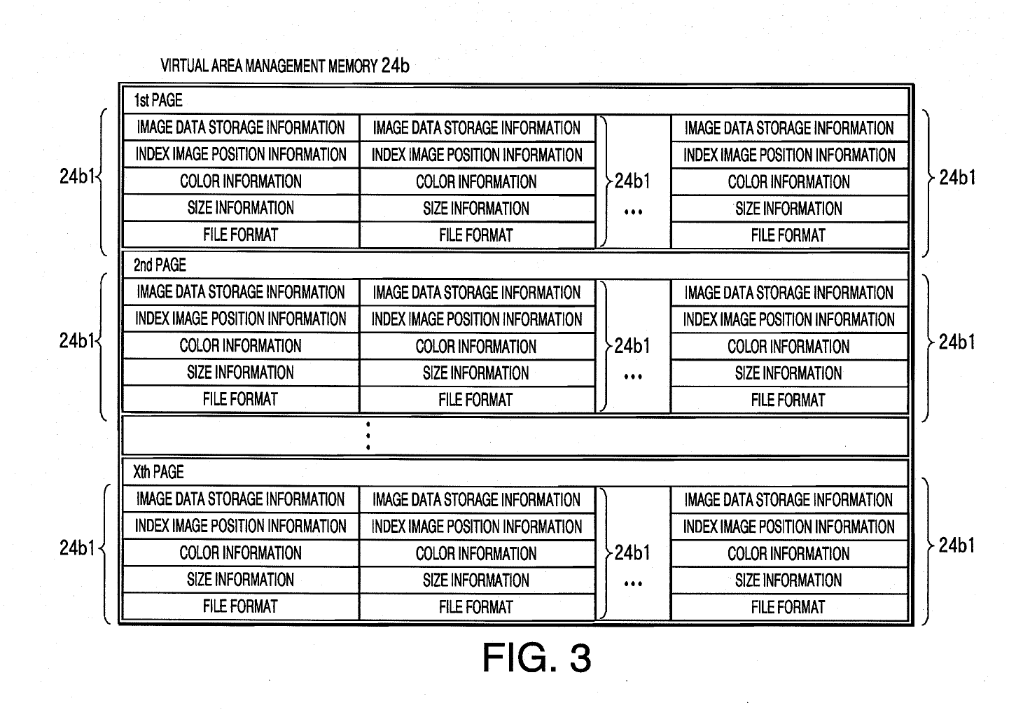

The EEPROM 24 is a non-volatile memory, in which a file storage memory 24a and a virtual area management memory 24b are provided. In the file storage memory 24a, image data generated by the scanner 3 is stored. The virtual area management memory 24b will be described later, referring to FIGS. 2 and 3.

The ASIC 26 controls the operation of each unit connected to the ASIC 26 under control of the CPU 21. Since the printer 2, the scanner 3 and the slot 32 are of the well-known configurations, detailed description thereof is omitted for brevity. A panel GA 27 is connected to the ASIC 26 and the operation keys 30 and outputs a code signal corresponding to an operated one of the keys 30 when the one of the keys 30 is depressed by the user. The CPU 21 executes a process to be executed in accordance with a predetermined key process table in response to receipt of the code signal from the panel GA 27.

The LCD controller 28 is connected to the ASIC 26 and the LCD 31. The LCD controller 28 makes the LCD 31 display information regarding the operation of the printer 2 or the scanner 3 or index images 44 (see FIGS. 2A and 2B) corresponding to the image data and the like under control of the CPU 21.

The touch panel 29 is connected to the ASIC 26 and is overlapped on the display area of the LCD 31. When the user touches the display area of the LCD 31 with a finger, the touch panel 29 detects the position touched by the user's finger, and inputs the position information to the ASIC 26.

The ASIC 26 is connected with a USB terminal 33 and an amplifier 34. The USB terminal 33 is used for connecting the ASIC 26 with an external device such as a computer, a digital camera or the like via a USB cable to transmit/receive data. The amplifier 34 is connected with a speaker 35, which is driven to output various sounds such as a calling sound, a denying sound, a message and the like. Further, the ASIC 26 is connected with an NCU (Network Control Unit) 36 and a modem 37 to realize the facsimile function. Optionally, in order to realize a communication with a computer or the like on a network, the ASIC 26 may further be connected with a network interface.

The MFP 1 configured as above operates in accordance with an operation mode (i.e., one of a scan mode, a copier mode and a facsimile mode) selected by the user.

As shown in FIG. 2A, when the scan mode is selected, the CPU 21 transmits a command to the LCD controller 28 to display index images 44 in the virtual area 42 defined within the display area 40 of the LCD 31. For the sake of simplicity, in FIGS. 2A and 2B, only parts of the index images 44 are given the reference numerals. Further, in FIGS. 2A and 2B, each index image 44 is schematically shown as a rectangle. In practice, the index images 44 may have various shapes. For example, reduced images generated from image data may be displayed. Optionally or alternatively, information regarding the image data (e.g., data generation date of the image data) may be indicated within the index image 44.

The index images 44 have a one-to-one correspondence with a plurality of pieces of the image data which were generated by the scanner 3 and stored in the memory. That is, the virtual area 42 virtually express each of the plurality of pieces of image data stored in the memory with the index images 44 so that the user can recognize the same. As will be described in detail later, when the user designates one of the index images 44 within the virtual area 42 and performs a predetermined operation, the image data corresponding to the designated index image 44 is retrieved from the memory and a preview image thereof is displayed in the display area 40.

Within the virtual area 42, a page number 45 indicating a presently displayed page (which is an example of group information described later) and a page forwarding icon 46 are displayed. The index images 44 displayed within the virtual area 42 are arranged in the order of page numbers. Therefore, even if all the index images cannot be displayed simultaneously within the virtual area 42, the display may be switched by pages, and the user can browse all the index images 44 subsequently.

After switching to the scan mode and when the index images 44 are displayed first, the MFP 1 displays the index images 44 to be included in the first page within the virtual area 42. Thereafter, upon each click of the page forward icon 46 by the user, the MFP 1 displays the index images 44 included in the next page for the virtual area 42.

As above, the user can forward the index images 44 by clicking the page forward icon 46 with visually checking the page number 45. Therefore, the user can select the desired page quickly, and browse the index images 44 included in the selected page with priority.

In addition to the above configuration, according the MFP 1, the user can set the displayed position of each index image 44 arbitrarily so that the user can find the desired index image within the virtual area 42 easily.

As shown in FIG. 2A, when new image data is generated with use of the scanner 3, the MFP 1 displays a file image 47 representing the newly generated image data outside the virtual area 42.

When the file image 47 is displayed, if the user designates a position within the virtual area 42 by touching the touch panel 29, the MFP 1 sets the position detected by the touch panel 29 as a display position of the index image 44 corresponding to the newly generated image data. It should be noted that the index images displayed on the same page are categorized to be included in the same group. The MFP 1 categorizes the new index image 44 in the page (i.e., the category) that is displayed on the virtual area 42 when the position within the virtual area 42 was selected (touched) by the user. Once the position of the index image 44 has been set, the MFP 1 displays the index image 44 corresponding to the newly generated image data at the set position within the page in which the index image 44 is categorized.

With the above configuration, the user can find out the index image 44 corresponding to the desired image data relatively easily based on a perceptive memory of the setting operation the user performed on the display area 40 with respect to the image data when newly generated.

For example, if the user makes it a rule to assign a left position for important image data, the index images 44 are arranged within the virtual area 42 in the order of importance in accordance with the user's subjective view. In such a case, the user can find an index image 44 corresponding to the subjective image data in accordance with the user's subjective impression on the image data and the self-imposed rule. In addition, according to such a configuration, the user can find the index image within the virtual area 42 without changing the name of the image data or categorizing with use of folders, the operational burden onto the user in terms of the management of the image data can be reduced.

Further, the user can set the display position of the index image 44 for the newly generated image data with checking the positional relationship of the index images 44 displayed within the virtual area 42. Therefore, the user can set the optimum position to meet the contents of the image data. For example, the user may view the virtual area 42 to find an index image 44 corresponding to the image data that is close to the newly generated image data, and designate a position close to the thus found index image 44 as the display position of the newly added index image 44. With such a configuration, the index images 44 of the image data of which contents are closely related will be displayed close to each other. Thus, the index images 44 are arranged so that the user can find the desired index image 44 easily and quickly.

It should be noted that, as shown in FIG. 2B, the file image 47 may be a reduced image of an image represented by the image data. With this configuration, the user can compare the contents of the newly generated image data with the index images 44 which are displayed within the virtual area 42, and determine an appropriate position of the index image 44 corresponding to the newly generated image data within the virtual area 44.

Further, as shown in FIGS. 2A and 2B, the CPU 21 creates the index image 44 such that the size of the index image 44 corresponds to the data size of the image data which is retrieved by the index image 44, and the index image 44 has a predetermined color. In FIGS. 2A and 2B, difference of the colors among the index images 44 is expressed by differentiating the hatchings on the index images 44.

According to the above configuration, the user can find the index image 44 corresponding to the desired image data easily in accordance with the visual characteristics (e.g., the size and color) of the index images 44. In some cases, a file format of the image data may be presumed based on the data size of the image data. In such cases, the user can guess the file format of the image data corresponding to the index image 44 based on the size thereof. Thus, the user can find the index image 44 corresponding to the desired image data quickly.

According to the exemplary embodiment, the image data generated by the scanner 3 is stored in a file storage memory 24a which is defined within the EEPROM 24a. Thus, the virtual area 42 expresses the status of the file storage memory 24a. The configuration may be modified such that the user can select whether the image data is stored in the file storage memory 24a or a memory card or the like inserted in the slot section 32. In such a case, the virtual area 42 may display the index images 44 representing the status of the selected one of the file storage memory 24a and the memory card or the like.

As shown in FIG. 3, the virtual area management memory 24b is a memory configured to store the index information 24b1 which is used for displaying the index images 44. By registering the index information 24b1 with the virtual area management memory 24b, the display position of the index image 44 is set.

Specifically, the index information 24b1 includes “image data storage information” representing an address of a memory at which the image data is stored, “index image position information” representing a display position of the index image, “color information” representing the display color of the index image, “size information” representing the data size of the image data, and “a file format” representing the file type of the image data.

When the new image data is generated by the scanner 3 and the file image 47 of the newly generated image data is displayed within the display area 40, if the user designate a position within the virtual area 42 by touching the touch panel 29, the index information 24b1 including the “index image position information” which is the position touched by the user and detected by the touch panel 29, the above described “image data storage information,” “size information,” “color information,” and the “file format” are generated and registered with the virtual area management memory 24b.

Thus, the MFP 1 can display the index images 44 corresponding to the image data stored in the memory within the virtual area 42 at respective positions set by the user based on the information stored in the storage area management memory 24b.

If one of the index images 44 displayed within the virtual area 42 is designated (touched) by the user and the position information is obtained by the touch panel 29, the image data corresponding to the positional information can be retrieved based on the “image data storage information.”

The CPU 21 displays the index image 44 with the display color represented by the “color information” and with the size corresponding to the “size information” which represents the data size of the image data.

According to the exemplary embodiment, the index information 24b1 is registered for each page. Therefore, the MFP 1 is capable of displaying only the index images 44 categorized into the group corresponding to the selected page from among the index images 44 corresponding to the image data stored in the memory.

If the MFP 1 is configured such that the user selects an internal memory (e.g., EEPROM 24) or an external memory (e.g., a memory card inserted in the slot section 32), the virtual area management memory 24b for both the internal memory and external memory may be provided.

A scanning process (FIG. 4) is executed when original sheets are placed on a predetermined position of the MFP 1 and scanning of the original sheets are instructed when the MFP 1 operates in the scan mode. When the scan mode is being selected, within the virtual area 42 of the display area 40 of the LCD 31, index images 44 are displayed (see FIG. 2A).

If the MFP 1 is configured such that the user is allowed to select whether the image data generated by the scanner 3 is stored in the internal memory (e.g., file storage memory 24a) or the external memory (e.g., a memory card inserted in the slot section 32), the user is required to make a selection before the scanning process is started.

When the scanning process starts, the CPU 21 drives the scanner 3 to scan the original sheet, generates image data (S402) and stores the image data in the memory (S403). Next, the CPU 21 displays the file image 47 representing the newly generated image data outside the virtual area 42 (S404) (see FIG. 2B).

The CPU 21 then judge whether a position within the display area 40 is touched by the user and the touch panel 29 detects the positional information (S406). If not (S406: NO), the CPU 21 pauses the scanning process. If affirmative (S406: YES), the CPU 21 judges whether a file image 47 is displayed outside the virtual area 42 (S407). At an initial stage, the judgment at S407 is affirmative, the CPU 21 next judges whether the user's operation was an operation to move the file image 47 (S408).

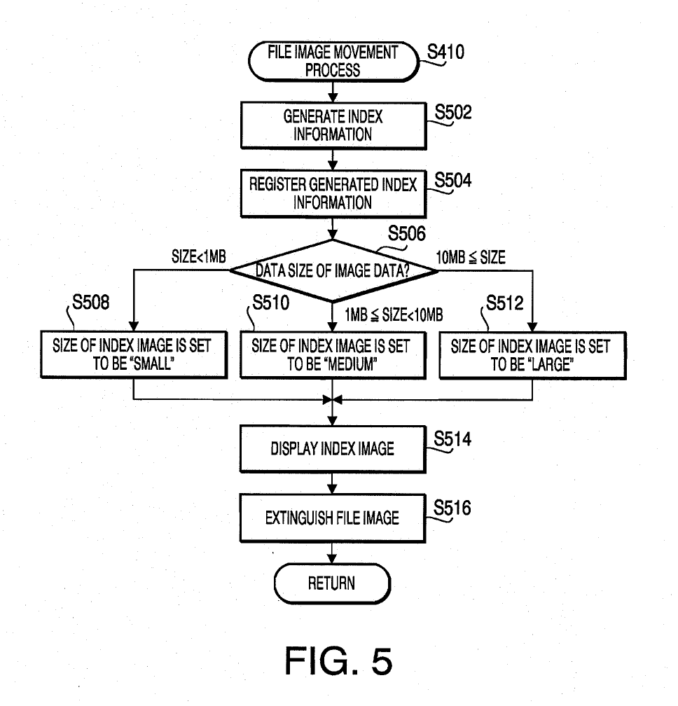

Specifically, the CPU 21 judges whether a portion within the virtual area 42 at which no image is displayed in designated and the position information of the designated position is detected by the touch panel 29. If the position information is detected (S408: YES), the CPU 21 executes the file image movement process (S409) and returns to S406. The file image movement process will be described referring to FIG. 5.

If the judgment at S407 or S408 is negative, the CPU 21 judges whether an operation for changing the page (i.e., the user's operation to click the page forward icon 46) is executed (S410). If affirmative (S410: YES), the CPU 21 selects a page subsequent to the currently displayed page and displays the index images 44 categorized in the group corresponding to the selected page (S411). If the judgment in S410 is negative, the CPU 21 skips S411.

Next, the CPU 21 judges whether an operation to change the color of the image is executed (S412). Specifically, the CPU 21 judges whether the user designates a display position of the index image 44 or the display position of the file image 47, and the position information is detected by the touch panel 29. If the judgment at S412 is negative, the CPU 21 executes other processes (S414) and returns to S406.

If the judgment at S412 is affirmative, the CPU 21 judges the current display color of the index image 44 or the file image 47 (S416). If the current display color is white (S416: WHITE), the CPU 21 changes the display color to YELLOW (S418). If the current display color is YELLOW (S416: YELLOW), the CPU 21 changes the display color to red (S420). If the current display color is red (S416: RED), the CPU 21 changes the display color to white (S422). As above, the user can change the display color simply by touching the index image 44 or the file image 47.

The CPU 21 next judges whether the change of the display color is for the index image (S424). If the judgment at S424 is negative, the CPU 21 returns to S406. If the judgment at S424 is affirmative, the CPU 21 reflects the change of the display color to the color information stored in the virtual area management memory 24b (S426), and then return to S406. After the above color changing process, the index image 44 is displayed with the color selected by the user. Thus, the user can distinguish the index images 44 by the color, which helps the user to find out a desired index image 44 based on the perceptive memory (i.e., the color).

A file image movement process shown in FIG. 5 is executed when the file image 47 is being displayed and the user touches a blank portion (i.e., a portion at which the index image 44, page number 45 or page forward icon 46 is not displayed).

The CPU 21 firstly generates the index information 24b1 which includes the position information detected by the touch panel 29 (i.e., the position information representing the touched position within the virtual area 42) as the “index image position information” (see FIG. 3) in S502. In the index information 24b1 generated in S502, the default value of the “color information” is included.

The CPU 21 then registers the generated index information 24b1, which is related to the currently displayed page, with the virtual area management memory 24b (S504). With this configuration, the display position of the index image 44 corresponding to the newly generated image data can be set based on the position information input through the touch panel 29, and the index image 44 can be categorized in the group corresponding to the page on which the displayed index images 44 are currently displayed.

Next, the CPU 21 judges the data size of the image data (S506). According to the exemplary embodiment, if the data size is less than 1 MB (Mega Bytes), the size of the index image 44 is set to be “small” (S508). If the data size of the image data is equal to or larger than 1 MB and less than 10 MB, the size of the index image 44 is set to be “medium” (S510). If the data size is equal to or larger than 10 MB, the size of the index image 44 is set to be “large” (S512).

The size of the JPEG format image data is typically less than 1 MB, while the size of the bitmap data is generally larger than 10 MB. Thus, using the size 1 MB and 10 MB as criteria to determine the size of the index image 44, the user can guess the size of the image data by viewing the index image 44.

In S514, the CPU 21 displays the index image 44 having the set size at the set display position, and extinguishes the file image 47 (S516). After completion of the file image movement process (S409), the CPU 21 returns to S406 of the scanning process (FIG. 4).

According to the scanning process (FIG. 4) and the file image movement process (FIG. 5), the user can browse the index images 44 for each page within the virtual area 42, and determine the page to which the index image 44 corresponding to the newly generated image data should be included. When the page in which the index image 44 is to be included is found, simply by touching a blank portion of the virtual area 42 when the index images 44 included in the page are displayed, the index image 44 corresponding to the newly generated image data can also be included in the page. As above, the page and position within the page of the index image 44 can be set easily.

The index images 44 included in each page are displayed at display positions that are set by the user. Therefore, the user can find the index image 44 easily, based on the memory of the page in which the index image 44 is included and the memory of the location, within the virtual area 42, at which the index image 44 is displayed, to retrieve the desired image data.

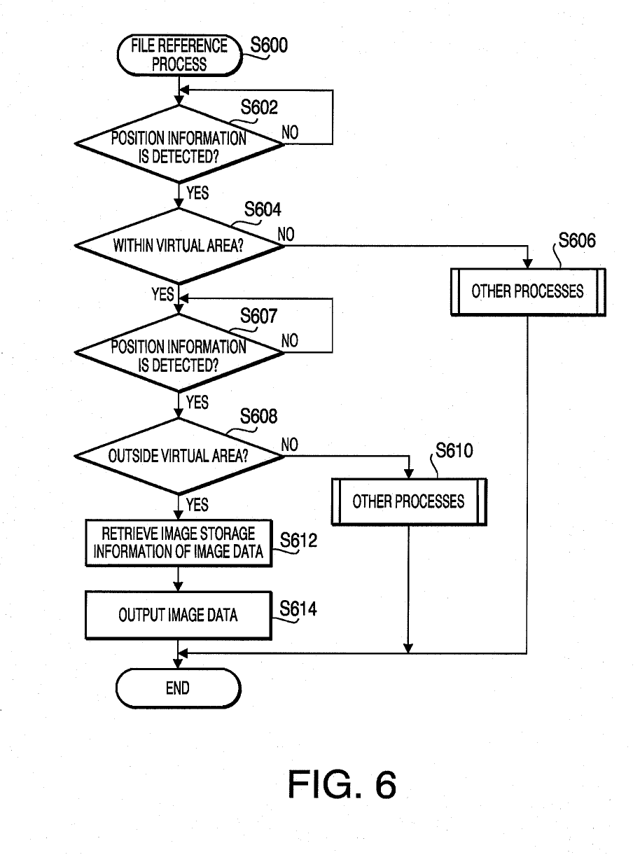

When the MFP 1 operates in the scan mode, a file reference process shown in FIG. 6 is periodically executed.

When the file reference process starts, the CPU 21 judges whether the user touches a position within the display area 40 of the LCD 31 and the position information is detected by the touch panel 29 (S602). If the judgment in S602 is negative, the CPU 21 pauses the file reference process. If the judgment in S602 is affirmative, the CPU 21 judges whether the user touches the position, within the virtual area 42, at which the index image 44 is displayed (S604). If the judgment at S604 is negative, the CPU 21 executes other processes (S606), and finishes the file reference process.

If the judgment at S604 is affirmative, the CPU 21 judges whether the user touches a position within the display area 40 of the LCD 31 and the position information is detected by the touch panel 29 (S607). If the judgment in S607 is negative, the CPU 21 pauses the file reference process. If the judgment in S607 is affirmative, the CPU 21 judges whether the user touched a position outside the virtual area 42 (S608). If the judgment at S608 is negative, the CPU 21 executes other processes such as change of display positions of the index images 44 (S610). Specifically, if the user firstly touches one of the index images 44 within the virtual area 42 and then the user touches another index image 44, the positions of the two index images 44 are exchanged and the change is reflected in the information stored in the virtual area management memory 24b.

If the judgment in S608 is affirmative, the CPU 21 retrieves the image storage information of the image data corresponding to the index image 44 based on the virtual area management memory 24b (see FIG. 3) (S612). Then, the CPU 21 retrieves the image data from the position represented by the image storage information, and outputs the retrieved image data based on the retrieved image data on the display area 40 of the LCD 43 (i.e., displays an image (a preview image), sends the retrieved image data to an external device and/or prints an image based on the retrieved image data) (S614). Preferably, the preview image may be displayed as large as possible by arrange the same over the virtual area 42, for example.

According to the file reference process, simply by touching a position within the virtual area 42 and then touching a position outside the virtual area 42, the user can retrieve the image data using the index image 44 displayed at the position the user firstly touches, and view the preview image which is generated based on the retrieved image, send the retrieved image data to an external device and/or print an image based on the retrieved image data.

It should be noted that the present invention should not be limited to the configuration described above, but can be modified in various ways without departing from the scope/aspects of the invention.

For example, in the exemplary embodiment described above, if the user touches the blank portion within the virtual area 42 when the file image 47 representing the newly generated image data is being displayed, the touched position is set as the display position of the index image 44 of the newly generated image data. This could be modified such that, if the user touches a position at which another index image 44 is displayed, a new index image 44 representing the newly generated image data is inserted in the touched position, and the previously displayed index image 44 may be shifted to another position (e.g., right, left, up or down).

In the exemplary embodiment described above, a case where the original includes a plurality of sheets is not mentioned. If a plurality of original sheets are scanned using the ADF (Automatic Document Feeder), a single index image 44 may be displayed within the virtual area 42 for the single piece of image data. Alternatively, a plurality of index images 44 are prepared for the plurality of original sheets, allowing that the displaying positions of the index images 44 can be set individually.

In the exemplary embodiment described above, if the index image 44 within the virtual area 42 is designated first, and then the position outside the virtual area 42 is designated, the image data corresponding to the firstly touched index image 44 is output. Alternatively, when the above operation is done, the image data corresponding to the firstly touched index image 44 may be processed in a different manner (e.g., deleted, etc.).

In the exemplary embodiment, the index images 44 are displayed for the image data generated by the scanner 3. The invention needs not be limited to such a configuration, and for data other than the image data generated by the scanner, the index images 44 may be displayed.

Optionally, the shape, size, appearance (color, pattern) of the index images 44 may be differentiated based on the file type of the image data. With such a configuration, the user can find the desired index image 44 quickly with reference to the file type, which is also represented by the index images 44.

Designation of a position on the display area 40 of the LCD 31 may be performed by dragging. In such a case, for example, a start position and an end position of a trajectory the user formed on the display area 40 may represent the positions designated by the user.

What is claimed is:

1. An image displaying device, comprising:
an image acquiring unit configured to acquire image data;
an image data storage configured to store the image data;
a display unit configured to display index images corresponding to the image data stored in the image data storage;
an input unit configured to allow a user to designate a position on the display unit and generate position information representing the designated position;
a display position setting unit configured to set a display position of each of the index images corresponding to the image data in accordance with the position information generated by the input unit, when the image data is acquired by the image acquiring unit; and
an index image displaying unit configured to display the index images corresponding to the image data stored in the image data storage at the respective display positions set by the display position setting unit.

2. The image displaying device according to claim 1,
wherein the index image displaying unit is configured to display the index images within a stored data displaying area defined on the display unit,
wherein the image displaying device further comprises a file image displaying unit configured to display a file image which represents the image data newly acquired by the image acquiring unit on the display unit, and
wherein, when the position within the stored data displaying area is designated through the input unit while the file image displaying unit displays the file image, the display position setting unit sets the designated position to be the display position at which the index image corresponding to the image data is displayed.

3. The image displaying device according to claim 2,
wherein, every time when a file image is displayed by the file image displaying unit displays a file image and a position within the stored data displaying area is designated with the input unit, the display position setting unit sets the designated position as the position at which the index image corresponding to the file image, which corresponds to the image data, is displayed.

4. The image displaying device according to claim 2, further comprising an output unit that is configured such that, when the positions, within the stored data displaying area, at which index images are displayed is designated and then a position outside the stored data displaying area is designated through the input unit, the output unit retrieves the image data corresponding to the index image displayed at the designated position within the stored data displaying area, and outputs the retrieved image data.

5. The image displaying device according to claim 2,
wherein the index images are categorized into a plurality of groups, each of the index images being associated with group information representing the group to which the index image belongs,
wherein the image displaying device further comprising a categorizing unit that is configured such that, if the file image displaying unit displays the file image representing the newly acquired image on the display unit and a position within the stored data displaying area is designated through the input unit, the categorizing unit categorizes the index image for the image data corresponding to the displayed file image into the group that is the same as the group in which the index images displayed within the stored data displaying area are categorized.

6. The image displaying device according to claim 5, further comprising a group information selection unit configured to select a piece of group information specifying one of the plurality of groups, and
wherein the index image displaying unit displays only the index images from among the index images corresponding to the image data stored in the image data storage and categorized into the group specified by the piece of the group information by the group information selection unit.

7. The image displaying device according to claim 1,
wherein the index image displaying unit displays the index images such that each index image has a size in accordance with the data size of the image data corresponding to the index image.

8. The image displaying device according to claim 1, further comprising:
a display color storage configured to store color information specifying display colors of the respective index images displayed by the index image displaying unit;
a display color changing unit which is configured such that, when a position, within the stored data displaying area, at which an index image is displayed is designated through the input unit, the display color changing unit changes the display color of the index image displayed at the designated position; and
a display color updating unit configured to update the color information stored in the display color storage by reflecting the display color changed by the display color changing unit.

9. The image displaying device according to claim 1,
wherein the image acquiring unit includes an image scanner which scans an image formed on an original and creates the image data.

10. The image displaying device according to claim 1,
wherein the input unit includes a touch panel provided on the display unit, the touch panel generating the position information representing a position touched by the user.
